(19) United States
(12) Patent Application Publication
(10) Pub. No.: US 2005/0119938 A1
(43) Pub. Date: Jun. 2, 2005

(54) Method for providing consumer benefits using a club program

(76) Inventors: Richard T. Smith, Bloomfield Hills, MI (US); Ronald T. Smith, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/989,899

(22) Filed: Nov. 16, 2004

Related U.S. Application Data
(60) Provisional application No. 60/557,281, filed on Mar. 29, 2004.
(60) Provisional application No. 60/520,712, filed on Nov. 17, 2003.

(51) Int. Cl. G06F 19/00

(52) U.S. Cl. 705/14

(57) ABSTRACT

A method for provides consumer benefits. The method includes the steps of allowing the member to redeem the coupon at a participating club program retailer, assigning bonus points associated with the redeemed coupon to the member account, and allowing the member to trade in an aggregate number of bonus points for a club program product or service associated with the club program.

### RELATED APPLICATIONS

The present claims priority to U.S. Provisional Application Nos. 60/520,712 and 60/557,281, filed Nov. 17, 2003 and Mar. 29, 2004, respectively, both of which are herein incorporated by reference.

### FIELD OF THE INVENTION

The present invention relates generally to retailer discount card loyalty programs, and more particularly, to a point-earning program for redemption on vacation travel, merchandise and other products.

### BACKGROUND OF THE INVENTION

Consumer loyalty programs exist on the retailer level and the product manufacturer/Brand level.

For example, many grocery store chains, which are comprised multiple retail outlets or retailers, have a customer loyalty program which requires that customers enroll in the program and identify themselves as a member when making any purchase. If a customer is enrolled and identifies themselves as member during a purchase, they may be provided with a discount on specified products.

The grocery store chain may also provide an additional incentive for the customer to buy groceries at one of their stores through additional promotions. For example, the chain may provide additional bonus dollars based on purchases made during a specified purchase period. Typically, such bonus dollars must be spent at one of the stores of the grocery store chain and cannot be redeemed in any other way.

Typically, the items on-sale or available at a discount through the program are chosen by the retail store chain and changes every week.

Thus, a manufacturer's product or products, which are available through the retail store, may be available on-sale often, intermittently, or never. From the perspective of the manufacturer then, these types of programs do not build customer loyalty to their product or products, but rather tend to build loyalty to the retail store.

From the customer's perspective, typically the only advantage to the customer is a discount or sale price. Furthermore, the customer must shop at the store which is offering the discounted item.

The present invention is aimed at one or more of the problems set forth above.

### SUMMARY OF THE INVENTION

In one aspect of the present invention, a marketing system using specific computer capabilities, software and a computerized database facilitates a point-earning program whereby consumers accumulate points for later redemption.

In another aspect of the present invention, a method for providing consumer benefits to a member of a club program. The method includes the steps of providing a coupon to the member. The coupon having an associated product or service and an associated number of bonus points. The method further includes the steps of, in response to the member having purchased the associated product or service from a participating club program retailer, allowing the member to redeem the coupon, assigning the bonus points associated with the redeemed coupon to the member account, and allowing the member to trade in an aggregate number of bonus points for a club program product or service associated with the club program.

In still another aspect of the present invention, a method for providing consumer benefits using a club program. The method includes the steps of providing an invitation communication to potential members of the club program, allowing a potential member to enroll in the club program to become a club program member and establishing a member account, and providing a coupon to the club program member, the coupon having an associated product or service and an associated number of bonus points. The method further includes the steps of, in response to the club program member having purchased the associated product or service from a participating club program retailer, allowing the club program member to redeem the coupon, assigning the bonus points associated with the redeemed coupon to the member account, and allowing the club program member to trade in an aggregate number of bonus points for a club program product or service associated with the club program.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a basic flow diagram of a method for providing consumer benefits using a club program, according to an embodiment of the present invention;

FIG. 2 is a second flow diagram of the method of FIG. 1;

FIG. 3 is a more detailed flow diagram of the method of FIG. 1;

FIG. 4 is a diagrammatic illustration of a sample logo for use with the method of FIG. 1; and,

FIG. 5 is a diagrammatic illustration of a sample coupon for use with the method of FIG. 1.

### DETAILED DESCRIPTION OF INVENTION

With reference to the Figures and in operation, the present invention provides a method for providing consumer benefits to members of a club program.

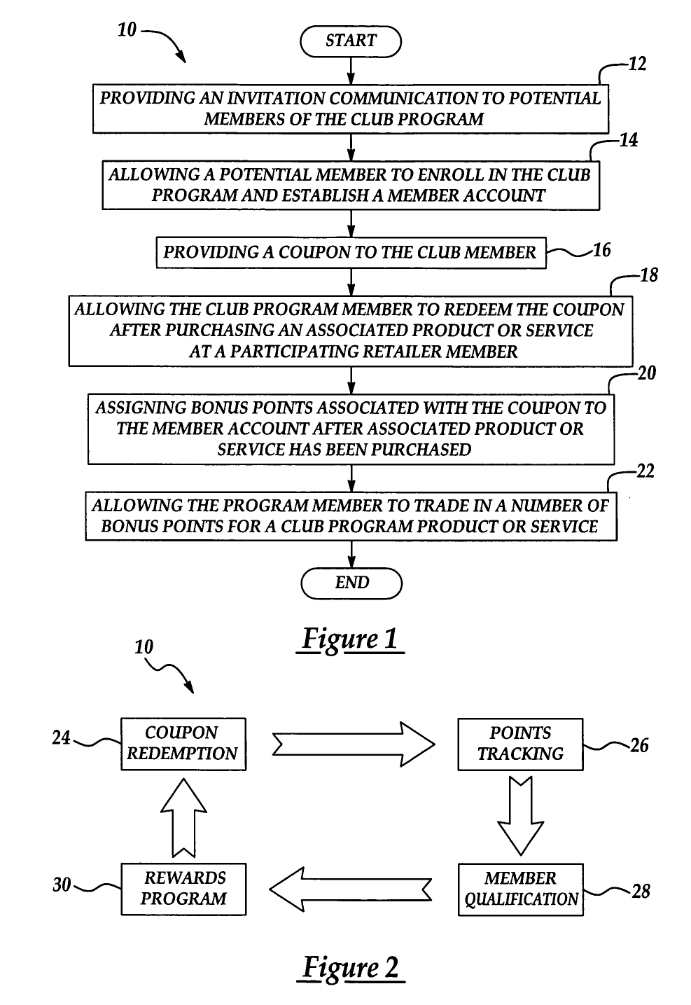

With specific reference to FIG. 1, in one aspect of the present invention, a method 10 provides consumer benefits. In a first process step 12, an invitation communication is provided to potential members of the club program. The invitation communication may be sent to potential members via any type of media communications, e.g., direct mail, e-mail, mass-mailing, advertisements in magazines, newspapers, and the like, etc . . . . The invitation communications may be directed to individuals, an identified set of potential members, or members of the public who view or otherwise become aware of the communication.

The potential members of the club program may respond to the invitation communication by deciding to enroll in the club program. In a second process step 14, the potential member is allowed to enroll and a member account is established. Typically, the member account is stored in database at a remote location and includes information which allows the member to be identified and contacted. The member account also includes an associated number of bonus points (see below).

The invitation communication may invite the potential member to enroll in the club program by filling out an enrollment card or form, making a telephone call, visiting a website, or other means. In one embodiment, enrollment requires that the potential member fill out an member application or questionnaire, which requests information allowing the potential member to be identified.

In a third step 16, a coupon is provided to the club program member. Each coupon has an associated product or service that may be bought and an associated number of bonus points. The coupon may be a paper coupon, an electronic coupon having an ID number. The member may have to print the coupon and present it at time of redemption or simply provide the ID number associated with the coupon. A sample coupon 64 is shown in FIG. 5. In the sample coupon, a coupon ID number is printed on the coupon 64 in the form of a bar code 66. The coupon 64 will also generally indicate the product or service associated with the coupon 64 and any special offer attributable to the purchase of the product or service, e.g., a dollar amount off the purchase price.

The coupon 64 may be provided in paper format and/or electronically. The coupon 64 may include a logo 62. The logo 62 may also be provided on the invitation communication and/or any other communication or advertisement.

In a fourth step 19, the member may redeem the coupon 64.

In a fifth step 20, in response to the club program member having redeemed the coupon 64, the bonus points associated with the redeemed coupon are assigned to the member account.

In a sixth step 22, once the member has accumulated enough bonus points and turned them in, the member may purchase the product or service for which they have qualified.

The club program includes club program products and/or service. Each product or service may have an associated number of bonus points. Each product or service may also have an associated value, such as a cost. In one embodiment, once the member has accumulated enough bonus points, a number of bonus points equal to the number of bonus points associated with the chosen product or service may be exchanged for the chosen product or service.

In another embodiment, the club member only qualifies for the purchase of the product or service through the accumulation of bonus points. Once the club member qualifies and redeems the number of qualifying points, the product or service may be purchased at a club or discount price.

In one aspect of the present invention, the club program products and/or services are provided by a third party, such as a club program supplier.

With reference to FIG. 2, another view of the method 10 is shown. Once a member is enrolled in the club program, the member may collect or receive various coupons (box 24) associated with the club program. As they redeem the coupons, the bonus points associated with the club program are tracked (box 26) and stored in the member's member account in a database. Once the member accumulates a sufficient number of bonus points, the member qualifies for the purchase of goods and/or services (box 28). A number of goods and/or services may be available in the club program. Each having an associated number of qualifying bonus points. In box 30, the member may trade in the number of qualifying bonus points for the associated good and/or service. In one embodiment, the good and/or service may also have an associated cost in terms of currency. Typically, the associated cost would be a discounted purchase price.

In one aspect of the present invention, the club program provides a catalog to potential members and members which may (1) describe the benefits of membership in the club program and (2) provide information of the products and/or services (or a sampling thereof) which are available through the club program. The catalog may include a description of each product and/or service, as well as an associated cost expressed in bonus points, and where appropriate, an associated cost expressed in currency, e.g., the discounted purchase price. The catalog may be provided in paper form and/or electronic form.

In one aspect of the present invention, the club program may be directed to leisure travel and the club program products and/or services may includes leisure travel packages including cruises and/or plane travel and/or hotel stays.

Typically redemption of the coupon 62 requires proof of purchase of the club program product and/or service, such as a receipt and a UPC label.

In another aspect, the products and/or services may be offered with a best price guarantee.

In general, a member may earn points through the redemption of coupons 64 which are associated with the club program. The coupons 62 may, for example, be marked with the logo 62 indicating association with the program. Types of coupons 62 which may be associated with the program include, but are not limited to printed coupons, on-line coupons, other media source coupons, tickets, vouchers, etc . . . . In one aspect of the present invention, the member receives the value of the coupon, e.g., a discount on the product being purchased, and a number of incentive points for the program when the coupon is redeemed.

Bonus points are tracked in and entered into a computerized database. The bonus points may be tracked in any number of suitable ways including, but not limited to, electronic entry, mailed submissions, phone, loyalty card, etc . . . .

Typically, members must earn a minimum number of incentive points to qualify to purchase travel and/merchandise. In one aspect of the present invention, the number of incentive points to qualify for the purchase may reduce or otherwise influence the purchase. For example, the merchandise or travel may be free based on a minimum number of accumulated incentive points.

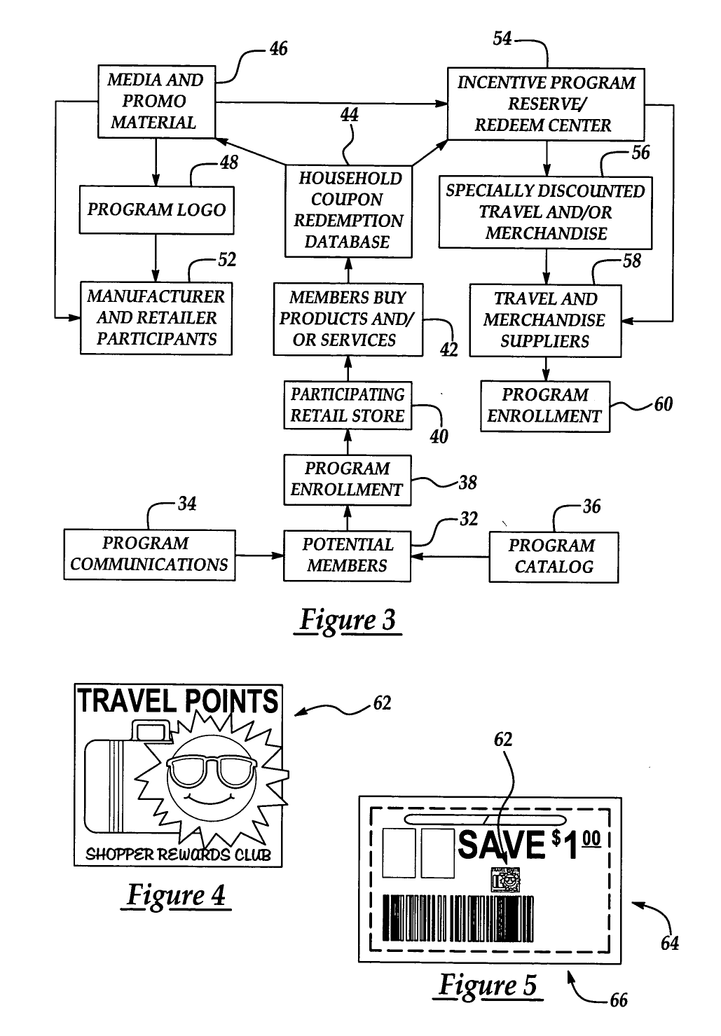

With specific reference to FIG. 3, in one embodiment of the present invention, the club program is a travel club program. Although the products and/or services are not limited to travel-related products and/or services, many of the products and/or services are related to travel. The club program includes one or more rewards programs for which a member of the club program may earn points, i.e., bonus points or travel points. The range in incentive and rewards options includes, but is not limited to, travel and/or merchandise and/or related services.

The potential members of the program 32, identified as “Mr. and Mrs. America” may become aware of the club program through a variety of sources 34 which may include, but are not limited to communications from various developed media source, a website, or program catalog 36. The program catalog 36 may be direct mailed or received from another source. The program catalog 36 may include sample prices ($$ plus incentive points) for sample travel and/or merchandise rewards. The catalog 36 may also include sample destinations and a best price guarantee.

If the potential members decide to enroll in the program, a membership questionnaire is filled out 38. The membership questionnaire may be a paper form or electronic form. Program enrollment may be accompanied by one or more of the following: an award of bonus incentive points or an opportunity to enter a sweepstakes contest. Membership in a retailer's program may or may not be required.

A potential member joins the Travel Club and completes the profiling questionnaire. The member may now be issued an ID card. The ID card has a personal and/or household ID number and/or bar code and/or other electronic device which differentiates the cardholder from other consumers. In another aspect, the ID card may be a smartcard.

In one aspect of the present invention, membership in the retailer's program is not required. Incentive points may then be accumulated by the members through redemption of coupons 62 (see above) at one or more retail stores 40. Incentive point accumulation is tracked using, e.g., store receipts and other proof, which may be entered by mail, an online process, a phone-in process, or any other suitable process.

The member buys items at a retailer or retail store 40. The purchase transaction data, including card ID number and items bought, are recorded electronically in a database. As the members buy products 42 using coupons and/or redeem coupons 62, the purchase or coupon redemption is stored in the household coupon redemption database 44. The purchase of specific primary goods or services awards the member various points based on a pre-defined schedule of point value per item. These points are also electronically recorded in the database 44 under that cardholder's ID number.

In one embodiment, the various transactional data elements (item or service code, price paid, date of purchase, discount coupon redemption, etc.) are electronically recorded for the transaction and are transmitted to individual retailer databases as well as a master database of multiple stores. A master account is established for the cardholder and points accumulated during the course of multiple transactions from multiple stores over time is tracked and contained in aggregate. The master database also has the capability to track points used for the purchase of leisure vacation packages and/or other merchandise.

Based on the product purchases by the member and/or coupon redemption, incentive (bonus or travel) points may be awarded to the members. The points themselves may or may not have intrinsic monetary value. Points can later be used as part of the purchase for leisure vacation packages and/or other secondary merchandise.

For example, as an example only, the program could assign 1 program point per $0.01 in coupon value. Thus, redemption of a $0.50 coupon would result in 50 program points being assigned to the member's account.

Other rules may be applied to bonus, including, but not limited to:
points may have an expiration date, based on date earned or some other date,
unused or unexpired points may or may not be rolled over to next purchase,
points may or may not be transferable,
the number of points earned may be limited to a maximum number,
points may or may not be exchanged for a cash value,
points may be redeemed for pre-defined products and/or purchased or custom packages, and,
products and/or services may be “reserved” before member qualification.

Specially discounted travel and/or merchandise 56 may then be offered to the members. The discounted travel and/or merchandise offered in an incentive program have been previously negotiated with suppliers of the travel and/or merchandise 58. The member utilizes an incentive program reserve/redeem center 54 to redeem, purchase, or reserve club program products and/or services. The incentive program reserve/redeem center 54 may be implemented on the internet.

In one embodiment, members become aware that specifically featured items can be purchased to earn points via various advertising mediums including print, websites, product packaging, broadcast, direct mail, etc. Advertising may be exclusive to certain media such as free-standing inserts. On-going advertising communications identifies items featured for points earning using the program logo 62. When the logo 62 is present, the member knows that item is eligible to earn points if purchased. Point value may be variable per item and is identified in the advertisement.

The utilization of different media and promotional material 46 is negotiated with club manufacturers and retailers 52. Certain products and/or retailers may be chosen as participants in the club program. The inclusion of the products, services, and/or retailers may be advertising in the promotional material 46 and identified by the program logo 48.

Other enhancements 60 may be made to the club program. These enhancements may be identified as pre-redemption, (during) travel enhancements, or post-redemption enhancements.

In another aspect of the present invention, retailers may become participants or retailer members of the program. As a result of negotiations with the retailers, retailers may be allowed to advertise and/or use the logo 62 in their own promotional materials. Additionally, the retailer members may be allowed to “purchase” additional bonus points which they may utilize in their promotions.

The retailer members may also be allowed to define their own loyalty programs through use of the club program and/or logo. For example, the retail member may provide additional discounts on luggage, side excursions, travel products (purchased in-store) and may provide other incentives, such as product samples and/or free or extra items.

In one aspect, the retailer members have a certain number of bonus points which may be utilized in their promotions. The club program may allow the retailer members to purchase additional bonus points.

In another aspect, custom promotional materials may be prepared to promote the program incentives. The custom promotional materials may include paid ads for previously selected and new points earning products, travel suppliers, ad or related travel/merchandise products (paid by the club program).

In still another aspect, the retailers and marketing copies may negotiate exclusivity with the program for exclusivity in terms of products, product brands, and/or geography.

In another aspect of the present invention, the program may offer sweepstakes in which use of the program allows the member to be included in an sweepstakes offer.

Another pre-redemption enhancements include a Club Program branded credit cards.

As discussed above, each coupon 62 has an associated number of points. In one embodiment, the associated number of points may be based on how the members has purchased the associated product and/or service. For example, the coupon could have a first number of associated points if the member purchased the product and/or service using a credit card and a second number of associated points if the member purchased the product and/or service using a check.

Types of travel redemption enhancements includes club program offers and/or samples of club program products presented to the member during their travel. Additional enhancements include offering additional trip offers, for redemption of additional travel points and/or money for club members.

Post-redemption enhancements include, but are not limited to, analyzing the data stored in the database 44 to profile member purchasing habits. Based on the analysis of the database, specialized member marketing and/or packages may be developed.

Obviously, many modifications and variations of the present invention are possible in light of the above teachings. The invention may be practiced otherwise than as specifically described within the scope of the appended claims.

1. A method for providing consumer benefits to a member of a club program, including the steps of:
providing a coupon to the member, the coupon having an associated product or service and an associated number of bonus points;
in response to the member having purchased the associated product or service from a participating retailer, allowing the member to redeem the coupon;
in response to the member having redeemed the coupon, assigning the bonus points associated with the redeemed coupon to the member account; and,
allowing the member to trade in an aggregate number of bonus points for a club program product or service associated with the club program.

2. A method, as set forth in claim 1, wherein the participating retailer has an associated number of bonus points, the method including the step of allowing the retailer to establish their own promotions using the bonus points.

3. A method, as set forth in claim 2, wherein the participating retailer may purchase additional bonus points.

4. A method, as set forth in claim 2, including the step of allowing the participating retailed to use a club program logo in their promotions.

5. A method, as set forth in claim 1, wherein the club program products and/or services are travel related.

6. A method, as set forth in claim 1, wherein some of the club program products are exclusive to a retailer member and/or set of retailer members.

7. A method, as set forth in claim 1, including the step of allowing the participating retailer to provide to members and/or members who have purchased specific goods and/or services, discounts on non-club program goods and/or services.

8. A method, as set forth in claim 1, wherein the club program product or service associated with the club program has an associated cost expressed in bonus points.

9. A method, as set forth in claim 1, including the step of providing a catalog to members, the catalog including a plurality of products and/or services associated with the club program, each product or service in the catalog having an associated cost expressed in bonus points.

10. A method, as set forth in claim 9, wherein the catalog is provided in paper form and/or electronic form.

11. A method, as set forth in claim 1, wherein the club program product or service has an additional cost expressed in a currency value.

12. A method, as set forth in claim 1, wherein the club program product or service is a leisure travel package.

13. A method, as set forth in claim 12, wherein the leisure travel package includes a cruise and/or plane travel.

14. A method, as set forth in claim 13, wherein the leisure travel package includes a hotel stay.

15. A method, as set forth in claim 1, wherein the club program has a best price guarantee with respect to the club program product or service.

16. A method, as set forth in claim 1, wherein the coupon may be provided in paper format and/or electronically.

17. A method, as set forth in claim 1, wherein the coupon includes a club logo.

18. A method, as set forth in claim 1, including the step of requiring proof of purchase of the club program product and/or service to redeem the coupon.

19. A method, as set forth in claim 18, wherein the proof of purchase may include a receipt and/or a UPC label.

20. A method, as set forth in claim 1, wherein the coupons are provided using public media.

21. A method, as set forth in claim 20, wherein the coupons are identified using a club program logo.

22. A method, as set forth in claim 1, wherein the club program products and/or services are provided by a club program supplier.

23. A method, as set forth in claim 1, wherein the coupon has an redemption value, the method including the step of applying the redemption value to the redemption value being applied to the purchase of the associated product or service.

24. A method for providing consumer benefits using a club program, including the steps of:
providing an invitation communication to potential members of the club program;
allowing a potential member to enroll in the club program to become a club program member and establishing a member account;
providing a coupon to the club program member, the coupon having an associated product or service and an associated number of bonus points;
in response to the club program member having purchased the associated product or service from a provider, allowing the club program member to redeem the coupon;
in response to the club program member having redeemed the coupon, assigning the bonus points associated with the redeemed coupon to the member account; and,
allowing the club program member to trade in an aggregate number of bonus points for a club program product or service associated with the club program.

25. A method, as set forth in claim 24, wherein the participating retailer has an associated number of bonus points, the method including the step of allowing the retailer to establish their own promotions using the bonus points.

26. A method, as set forth in claim 25, wherein the participating retailer may purchase additional bonus points.

27. A method, as set forth in claim 25, including the step of allowing the participating retailer to use a club program logo in their promotions.

28. A method, as set forth in claim 24, wherein the club program products and/or services are travel related.

29. A method, as set forth in claim 24, wherein some of the club program products are exclusive to a retailer member and/or set of retailer members.

30. A method, as set forth in claim 24, wherein the club program product or service associated with the club program has an associated cost expressed in bonus points.

31. A method, as set forth in claim 24, including the step of requiring the potential member to fill out a membership questionnaire when enrolling in the club program.

32. A method, as set forth in claim 24, including the step of providing a catalog to potential members and/or club program members, the catalog including a plurality of products and/or services associated with the club program, each product or service in the catalog having an associated cost expressed in bonus points.

33. A method, as set forth in claim 32, wherein the catalog is provided in paper form and/or electronic form.

34. A method, as set forth in claim 24, wherein the club program product or service has an additional cost expressed in a currency value.

35. A method, as set forth in claim 24, wherein the club program product or service is a leisure travel package.

36. A method, as set forth in claim 35, wherein the leisure travel package includes a cruise and/or plane travel.

37. A method, as set forth in claim 35, wherein the leisure travel package includes a hotel stay.

38. A method, as set forth in claim 24, wherein the club program has a best price guarantee with respect to the club program product or service.

39. A method, as set forth in claim 24, wherein the coupon may be provided in paper format and/or electronically.

40. A method, as set forth in claim 24, wherein the coupon includes a club logo.

41. A method, as set forth in claim 24, including the step of requiring proof of purchase of the club program product and/or service to redeem the coupon.

42. A method, as set forth in claim 41, wherein the proof of purchase may include a receipt and/or a UPC label.

43. A method, as set forth in claim 24 wherein the coupons are provided using public media.

44. A method, as set forth in claim 22, wherein the coupons are identified using a club program logo.

45. A method, as set forth in claim 24, wherein the club program products and/or services are provided by a club program supplier.

46. A method, as set forth in claim 24, wherein the coupon has an redemption value, the method including the step of applying the redemption value to the redemption value being applied to the purchase of the associated product or service.
